(19) United States
(12) Patent Application Publication
(10) Pub. No.: US 2012/0134360 A1
(43) Pub. Date: May 31, 2012

(54) DEVICE AND METHOD FOR PROCESSING NETWORK PACKET

(76) Inventors: CHENG-WEI DU, Suzhou City (CN); Hong-June Hsue, Hsinchu City (TW); Chun-Kuei Chang, Miaoli County (TW); Chen-Yi Cheng, Tainan City (TW)

(21) Appl. No.: 13/307,005

(22) Filed: Nov. 30, 2011

(30) Foreign Application Priority Data
Nov. 30, 2010 (CN) 201010568219.3

(51) Int. Cl. H04L 12/56

(52) U.S. Cl. 370/392; 370/389

(57) ABSTRACT

A device for processing a network packet includes a capturing unit, a look-up table supplying unit, a preprocessing unit and a control unit. The capturing unit is utilized for capturing an information from the network packet. The look-up table supplying unit is utilized for supplying a look-up table. The preprocessing unit is coupled to the capturing unit and the look-up table supplying unit, for comparing the information with the look-up table to generate a comparison result. The control unit is coupled to the preprocessing unit, for choosing a processing rule to process the network packet according to the comparison result.

### BACKGROUND OF THE INVENTION

1. Field of the Invention

The present invention relates to a mechanism for processing a network packet, and more particularly, to a device and a related method for processing a network packet by checking in advance to see whether the Internet Protocol (IP) address of a network packet conforms to a range and for supporting the execution of multiple actions with a simplified storage manner.

2. Description of the Prior Art

Access control lists (ACLs) are widely used in various systems or communication devices. When receiving network packets, a system or communication device filters the received network packets with an access control list to thereby distribute the received network packets to respective destinations.

Please refer to FIG. 1, which is a diagram of a prior art access control list 100. It is assumed that the access control list 100 includes 8 entries En0-En7 and 3 fields Media Access Control (MAC) address, IP address, and action. A prior art network device receives a data stream. During processing of the data stream, if the data stream arrives at a processing module of the access control list 100, the processing module firstly refers to the access control list 100 to check whether a network packet is permitted to enter the processing module, and performs corresponding processing according to the check result. For example, regarding processing of a network packet which conforms to a rule, a corresponding action for the network packet is executed. For example, such an action may be asking the network device to deny the network packet or permitting the network device to further process the network packet.

As shown in FIG. 1, the network device can extract values of the IP address field and the MAC address field. In the entry En0, the network device firstly checks whether the MAC address of the network packet is 0090c3000001, and checks whether the IP address is 192.168.1.10. When the MAC address of the network packet is 0090c3000001 and the IP address is 192.168.1.10, an action 0001, such as denying the network packet, is executed; otherwise, the action 0001 is not executed. Similarly, in the entry En1, the network device firstly checks whether the MAC address of the network packet is 0080c1000008, and checks whether the IP address is 192.168.1.10. When the MAC address of the network packet is 0080c1000008 and the IP address is 192.168.1.10, an action 0010, such as further processing the network packet, is executed; otherwise, the action 0010 is not executed. The rest can be done in the same manner, and the flow is not stopped until the comparison of all the entries En0-En7 is ended or one matched entry is found. Some processing modules of the access control list 100 can also be designed to continue the comparison applied to the following unchecked entries after finding a matched rule and performing a corresponding action. Thus, multiple actions are executed for a single network packet.

In addition, with the increasing abundance of network applications, it is required that a network device should be able to process a data stream more finely, which leads to an increase in the number of access control list entries to be processed by the network device. This further gives rise to the requirement for the processing speed of the access control list processing module. If the comparison speed is too slow, the forwarding speed of the data stream will be affected, and the network device will inevitably be the bottleneck of data transmission efficiency. Accordingly, a processing method with more expandability is required, such as a parallel comparison method (i.e., a method which extracts the required information in the packet, arranges the extracted information according to an expected format, compares the information with all of the access control list rules in a single step, and then chooses the comparison result). Currently, the parallel comparison method widely uses a ternary content addressable memory (TCAM) or a content addressable memory (CAM) to store the access control list rules, and then processes according to the comparison result corresponding to the access control list rules stored in the ternary content addressable memory or content addressable memory. However, the ternary content addressable memory or content addressable memory can only perform comparison upon the extracted information in a bit-by-bit manner. Therefore, it is difficult to realize the concept of range check by checking whether a certain feature of a packet belongs to a value in a certain range.

On the other hand, the requirement for the functionality of a network device is increasingly high, and there are more processing types of actions associated with network packet processing. For example, the processing types may include encryption, internal virtual local area network (LAN) identifier (VID) translation, external VID translation, rate-limiting, re-direction, and dropping. Current practice in the art is to expand the actions in the access control list so as to directly provide more processing manners for adequately processing network packets. There are two common implementations. One implementation is that each access control list rule can only correspond to one action, and if various processing for a network packet is needed, a plurality of access control list rules must be used. The other implementation is that all of the actions are provided for each access control list rule, where some actions are disabled by a setting. Each of the two implementations has advantages and disadvantages. As for the former, the information provided by access control list rules is less. Thus, the cost required by a single access control list rule is low due to fewer bits used. However, when various processing for the same type of network packets is performed, multiple access control list rules are required. Thus, more access control list rules will be additionally consumed because each rule provides only one action. As for the latter, each access control list rule can provide sufficient information. Therefore, if there are various processing requirements for the same type of network packets, one access control list rule can simply meet these processing requirements. However, because each access control list rule is required to provide all possible actions, the cost of a single access control list rule is high due to more bits used. And in a practical application, each data stream generally won't simultaneously use all of the actions, which leads to a waste of bit space.

Therefore, how to provide sufficient information and reduce the cost or accelerate the processing speed of the access control list processing module becomes an important topic for designers in the pertinent field.

### SUMMARY OF THE INVENTION

One of the objectives of the present invention is to provide a device and a related method for processing a network packet to solve the problem in the prior art.

One embodiment of the present invention discloses a device for processing a network packet, including a capturing unit, a look-up table supplying unit, a preprocessing unit and a control unit. The capturing unit is utilized for capturing an information from the network packet. The look-up table supplying unit is utilized for supplying a look-up table. The preprocessing unit is coupled to the capturing unit and the look-up table supplying unit, for comparing the information with the look-up table to generate a comparison result. And the control unit is coupled to the preprocessing unit, for choosing a processing rule to process the network packet according to the comparison result.

Another embodiment of the present invention discloses a device for processing a network packet, including a capturing unit, a preprocessing unit, a searching unit, a decoding unit and an executing unit. The capturing unit is utilized for capturing an information from the network packet. The preprocessing unit is coupled to the capturing unit, for comparing the information with a look-up table to generate a comparison result. The searching unit is utilized for determining an encoded data corresponding to the comparison result according to the comparison result. The decoding unit is coupled to the searching unit, for decoding the encoded data to determine at least one action designated by the processing rule corresponding to the comparison result. And the executing unit is coupled to the decoding unit, for processing the network packet by executing the at least one action designated by the processing rule corresponding to the comparison result.

Another embodiment of the present invention discloses a method for processing a network packet, including the steps of: capturing an information from the network packet; supplying a look-up table; comparing the information with the look-up table to generate a comparison result; and choosing a processing rule to process the network packet according to the comparison result.

Another embodiment of the present invention discloses a method for processing a network packet, including the steps of: capturing an information from the network packet; comparing the information with a look-up table to generate a comparison result; determining an encoded data corresponding to the comparison result according to the comparison result; decoding the encoded data to determine at least one action designated by the processing rule corresponding to the comparison result; and processing the network packet by executing the at least one action designated by the processing rule corresponding to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art access control list.

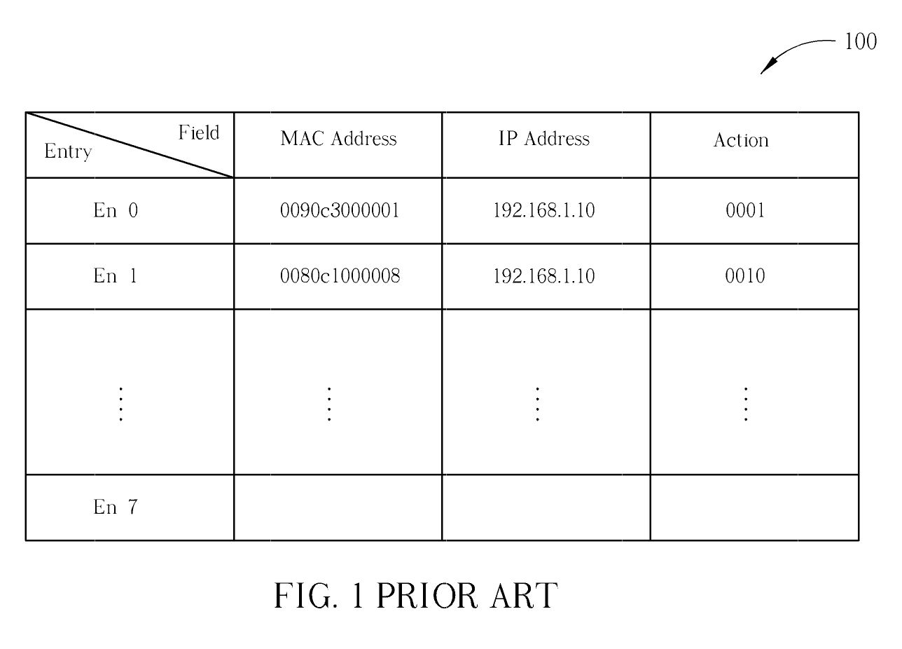

FIG. 2 is a diagram illustrating a device for processing a network packet according to a first embodiment of the present invention.

FIG. 3 is a diagram illustrating an embodiment of a look-up table supplied by a look-up table supplying unit.

FIG. 4 is a diagram illustrating a ternary content addressable memory of the present invention.

FIG. 5 is a diagram illustrating a device for processing a network packet according to a second embodiment of the present invention.

FIG. 6 is a diagram illustrating an embodiment of processing a network packet with access control list rules.

FIG. 7 is a diagram illustrating a device for processing a network packet according to a third embodiment of the present invention.

FIG. 8 is a flowchart of an operation example of a method for processing a network packet according to the present invention.

FIG. 9 is a flowchart of another operation example of a method for processing a network packet according to the present invention.

FIG. 10 is a flowchart of yet another operation example of a method for processing a network packet according to the present invention.

### DETAILED DESCRIPTION

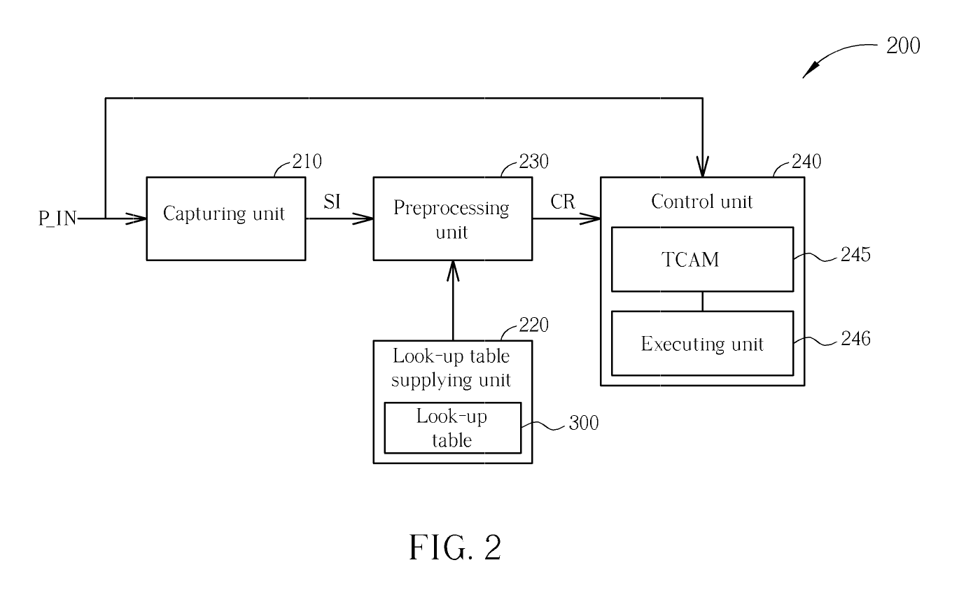

Please refer to FIG. 2, which is a diagram illustrating a device 200 for processing a network packet P_IN according to a first embodiment of the invention. As shown in FIG. 2, the device 200 comprises a capturing unit 210, a look-up table supplying unit 220, a preprocessing unit 230 and a control unit 240. The capturing unit 210 is utilized for capturing an information SI from the network packet P_IN. In this embodiment, the information SI is illustrated by a source IP address captured from a corresponding field included in the network packet P_IN, but this is not meant to be a limitation of the present invention. In other embodiments, the information SI may be a source MAC address, a VID, or a Transmission Control Protocol/User Datagram Protocol (TIP/UDP) port. The look-up table supplying unit 220 is utilized for supplying a look-up table 300. The preprocessing unit 230 is coupled to the capturing unit 210 and the look-up table supplying unit 220, and utilized for comparing the information SI with the look-up table 300 to generate a comparison result CR. And the control unit 240 is coupled to the preprocessing unit 230, and utilized for choosing a processing rule to process the network packet P_IN according to the comparison result CR. In this embodiment, the control unit 240 includes a ternary content addressable memory 245 and an executing unit 246, where the ternary content addressable memory 245 has at least one memory entry utilized to store the comparison result CR, and the executing unit 246 is utilized for reading the comparison result CR from the memory entry and for processing the network packet P_IN by executing at least one action designated by the processing rule corresponding to the comparison result CR.

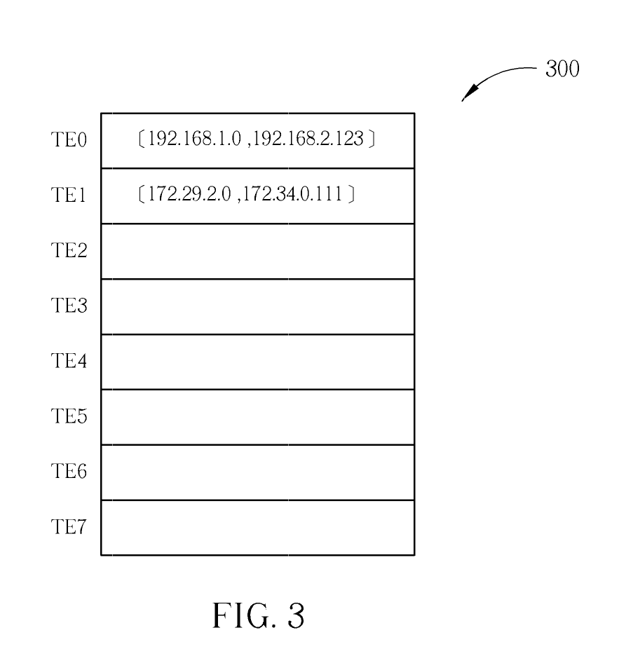

Please refer to FIG. 3, which is a diagram illustrating an embodiment of the look-up table 300 supplied by the look-up table supplying unit 220 shown in FIG. 2. As shown in FIG. 3, the look-up table 300 has a plurality of table entries which record a plurality of information ranges respectively. By way of example, in this embodiment, the look-up table 300 has 8 table entries TE0-TE7, and records source IP address ranges. However, this is not meant to be a limitation of the present invention. As shown in FIG. 3, a table entry TE0 records a source IP address range of [192.168.1.0, 192.168.2.123], a table entry TE1 records a source IP address range [172.29.2.0, 172.34.0.111], and other table entries TE2-TE7 are not configured yet.

The operation of the device 200 is detailed as follows. Please refer to FIGS. 2 and 3. Firstly, when the network packet P_IN arrives at the device 200, the capturing unit 210 captures a source IP address from the corresponding field in the network packet P_IN. Then, the preprocessing unit 230 compares the source IP address with the 8 table entries TE0-TE7 to generate a comparison result CR, wherein the comparison result CR have bits each corresponding to one table entry to indicate whether the source IP address falls within a configured range of one table entry. For example, if the content of the bit is “0”, it indicates that the source IP address of the network packet P_IN doesn't fall within the configured range of the table entry, and if the content of the bit is “1”, it indicates that the source IP address of the network packet P_IN falls within the configured range of the table entry. In a case where the source IP address of the network packet P_IN is 192.168.2.1, the comparison result CR is 0x01. In another case where the source IP address of the network packet P_IN is 172.29.2.3, the comparison result CR is 0x02. In yet another case where the source IP address of the network packet P_IN is 224.0.0.1, the comparison result CR is 0x00.

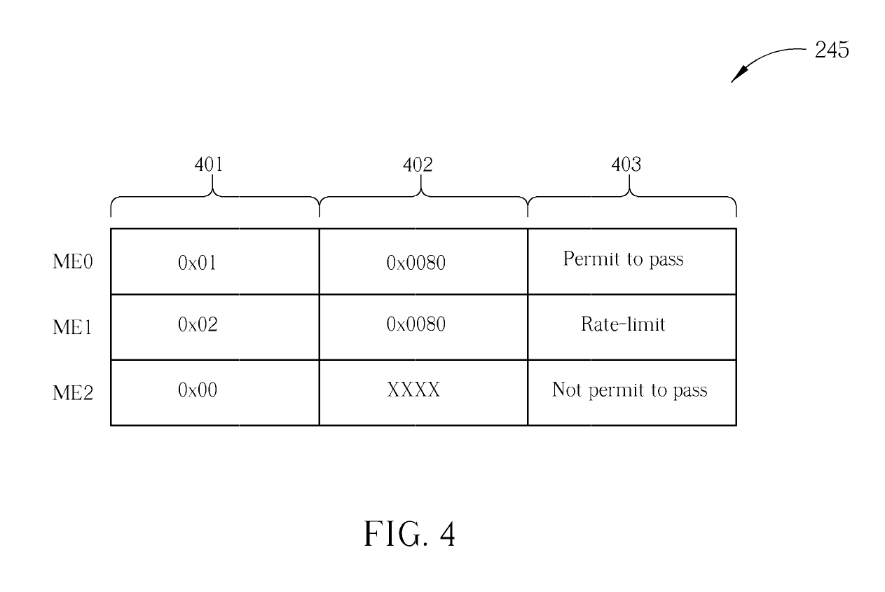

The control unit 240 stores data, including the comparison result CR, information of the network packet (e.g., a TCP source port), other information generated during the network packet processing process (e.g., the corresponding action), etc., into a memory entry of the ternary content addressable memory 245. Please refer to FIG. 4, which is a diagram illustrating an embodiment of the ternary content addressable memory 245 shown in FIG. 2. Each memory entry (e.g., ME0-ME2) has a field 401 for storing the comparison result CR, a field 402 for storing the information of the TCP source port, and a filed 403 for storing the corresponding action. In this embodiment, a pre-configured processing rule defines that only the network packets with source IP addresses in the range of [192.168.1.0, 192.168.2.123] will be permitted to pass, the network packets with source IP addresses in the range of [172.29.2.0, 172.34.0.111] will be rate-limited, and other network packets are not permitted to pass. Based on the configuration of the ternary content addressable memory 245, network packets that satisfy the passing condition would correspond to the memory entry ME0, and the executing unit 246 therefore executes the action corresponding to the memory entry ME0 to thereby permit the network packets to pass and undergo further processing; network packets with source IP addresses falling in the range of [172.29.2.0, 172.34.0.111] would correspond to the memory entry ME1, and the executing unit 246 therefore executes the action corresponding to the memory entry ME1 to rate-limit the network packet; and other network packets that correspond to the memory entry ME2 are not allowed to pass due to the corresponding action indicated by the memory entry ME2.

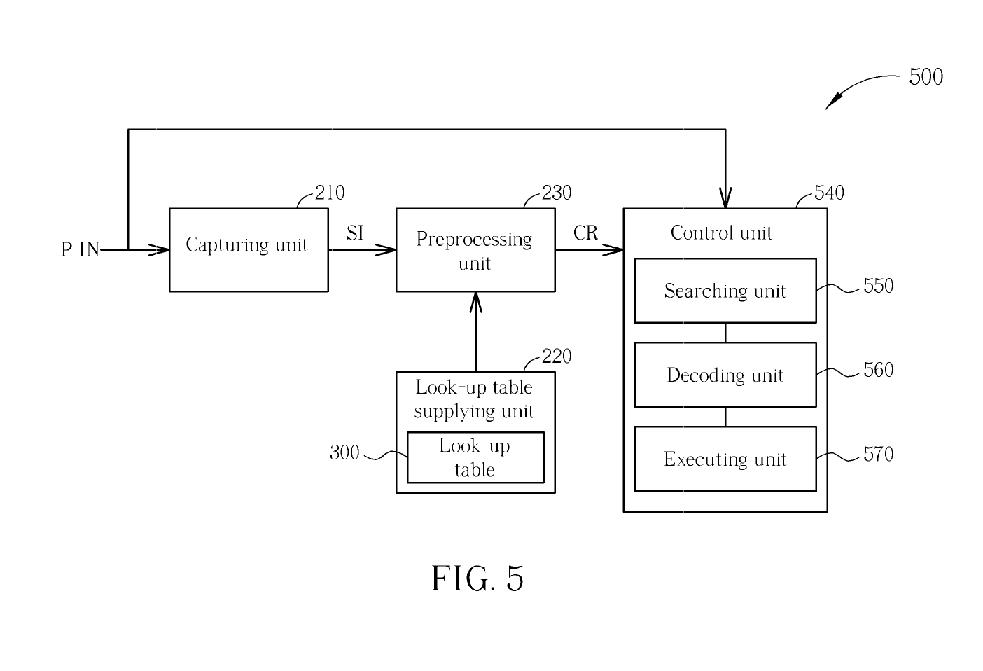

Please refer to FIG. 5, which is a diagram illustrating a device 500 for processing a network packet according to a second embodiment of the invention. The device 500 shown in FIG. 5 is similar to the device 200 shown in FIG. 2, and the difference therebetween is that the control unit 540 includes a searching unit 550, a decoding unit 560 and an executing unit 570. As shown in FIG. 5, the searching unit 550 is utilized for determining an encoded data according to the comparison result CR, where the encoded data corresponds to the comparison result CR. The decoding unit 560 is coupled to the searching unit 550, and utilized for decoding the encoded data to determine at least one action designated by a processing rule corresponding to the comparison result CR. Besides, the executing unit 570 is coupled to the decoding unit 560, and utilized for processing the network packet P_IN by executing the at least one action designated by the processing rule corresponding to the comparison result CR. It should be noted that in this embodiment, either of each encoded data and the content of the corresponding action determined by each encoded data is stored by bits of a fixed bit length.

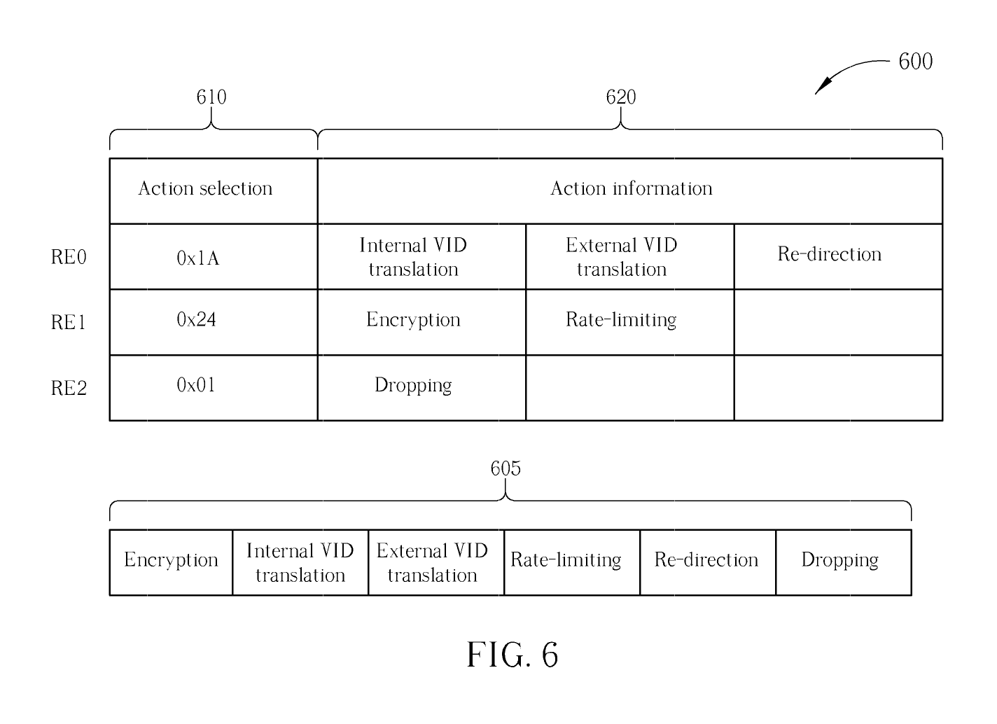

Please refer to FIG. 6, which is a diagram illustrating an embodiment of processing a network packet according to the present invention. Action options 605 and an access control list rule 600 are shown in FIG. 6. Each entry in the access control list rule 600 includes an action selection field 610 and an action information field 620. Generally, each network packet usually asks for various processing at the same time. In this embodiment, the exemplary various processing includes encryption, the internal VID translation, the external VID translation, rate-limiting, re-direction, and dropping. As shown in the action options 605, each action is represented by one bit. Therefore, there are 6 bits used in this embodiment, wherein the lowest bit represents dropping, and the highest bit represents encryption. Regarding other bits, they are shown in FIG. 6 and can be readily understood by those skilled in the art. If a corresponding bit is set by “1”, it means that the action information field 620 provides information of the corresponding action. Otherwise, it means that the action information field 620 doesn't provide information of the corresponding action. Each action information field 620 can be interpreted as any format of supported actions. Each entry of the access control list rule 600 in this embodiment can support up to three actions. However, this is not meant to be a limitation of the invention. In other embodiments of the present invention, supporting more actions is feasible.

As shown in FIG. 6, in an entry RE0, when the searching unit 550 determines an encoded data in the action selection field 610 to be 0x1A according to the comparison result CR, the decoding unit 560 decodes the encoded data (i.e., 0x1A) to determine at least one action designated by the processing rule corresponding to the comparison result CR as the internal VID translation, the external VID translation, and re-direction, and the action information field 620 therefore provides the information associated with the internal VID translation, the external VID translation, and re-direction. If the searching unit 550 determines an encoded data in the action selection field 610 to be 0x24 according to the comparison result CR, the decoding unit 560 decodes the encoded data (i.e., 0x24) to determine at least one action designated by the processing rule corresponding to the comparison result CR as encryption and rate-limiting, and the action information field 620 therefore provides the information associated with encryption and rate-limiting. The rest can be deduced by analogy.

It should be noted that in this embodiment, either of each encoded data in the action selection field 610 and the content of the corresponding action determined by each encoded data in the action information field 620 is stored by bits of a fixed bit length. For example, in a general condition, the virtual VID translation needs to provide a new VID, and thus at least 12 bits are required. Therefore, the internal VID translation and the external VID translation require 24 bits in total. Re-direction generally needs to provide the destination port number. Taking 48 ports for example, at least 6 bits are required. Rate-limiting needs to provide rate configuration. In this embodiment, it is assumed that 10 bits are required. Encryption needs to provide a key. In this embodiment, it is assumed that 16 bits are required. Besides, regarding the dropping action, it is assumed that 2 bits are required. If entries of the processing rule are realized by a full expansion manner, at least 58 bits (i.e., 16+12+12+10+6+2=58) are required. It should be noted that, in this embodiment, each action information field 620 needs to support 3 actions at most, and thus 40 bits (i.e., 16+12+12=40) are required. With the length of the action selection field 610 taken into consideration, 46 bits in total can support 6 actions (please note that 3 actions are chosen from 6 supported actions). Compared with the conventional design, the embodiment of the present invention has a 20% reduction in the used storage space. As a result, the storage space used by the access control list rules is reduced, and so is the cost.

Please note that in this embodiment, the action selection field 610 and the action information field 620 are integrated into the same entry, but this is not meant to be a limitation of the present invention. In other embodiments, separating the action selection field 610 and the action information field 620 also obeys the spirit of the present invention.

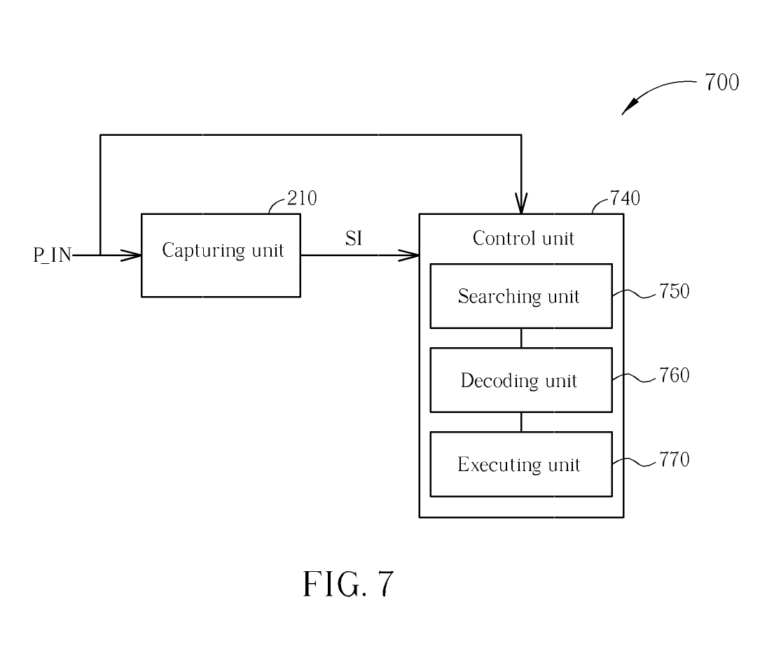

Please refer to FIG. 7, which is a diagram illustrating a device 700 for processing a network packet according to a third embodiment of the present invention. The device 700 shown in FIG. 7 is similar to the device 500 shown in FIG. 5, and the difference therebetween is that the device 700 lacks the look-up table supplying unit 220 and the preprocessing unit 230 as compared with the device 500. In the embodiment shown in FIG. 7, the control unit 740 is coupled to the capturing unit 210, and utilized for choosing a processing rule to process a network packet P_IN according to an information SI generated from the capturing unit 210. However, in the embodiment shown in FIG. 5, the control unit 540 is coupled to the preprocessing unit 230, and utilized for choosing a processing rule to process a network packet P_IN according to a comparison result CR. That is to say, the device 700 doesn't need to check in advance for determining whether an information of the network packet conforms to a range. The operational principle of a searching unit 750, a decoding unit 760 and an executing unit 770 is similar to that of the searching unit 550, the decoding unit 560 and the executing unit 570 shown in FIG. 5. As those skilled in the art can readily understand how the device 700 processes the network packet according to the action options 605 and the access control list rule 600 shown in FIG. 6 after reading above operation description of FIGS. 5 and 6, further description is omitted here for brevity.

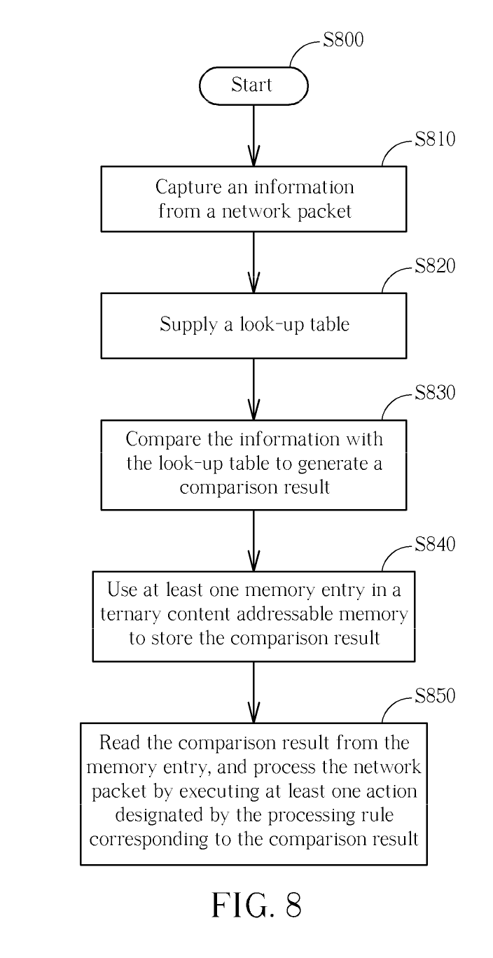

Please refer to FIG. 8, which is a flowchart of an operation example of a method for processing a network packet according to the present invention. The method includes the following steps:

Step S800: Start.

Step S810: Capture an information from a network packet.

Step S820: Supply a look-up table.

Step S830: Compare the information with the look-up table to generate a comparison result.

Step S840: Use at least one memory entry in a ternary content addressable memory to store the comparison result.

Step S850: Read the comparison result from the memory entry, and process the network packet by executing at least one action designated by the processing rule corresponding to the comparison result.

The related operation details can be readily known from the steps shown in FIG. 8 and the elements shown in FIG. 2. Further description is omitted here for brevity.

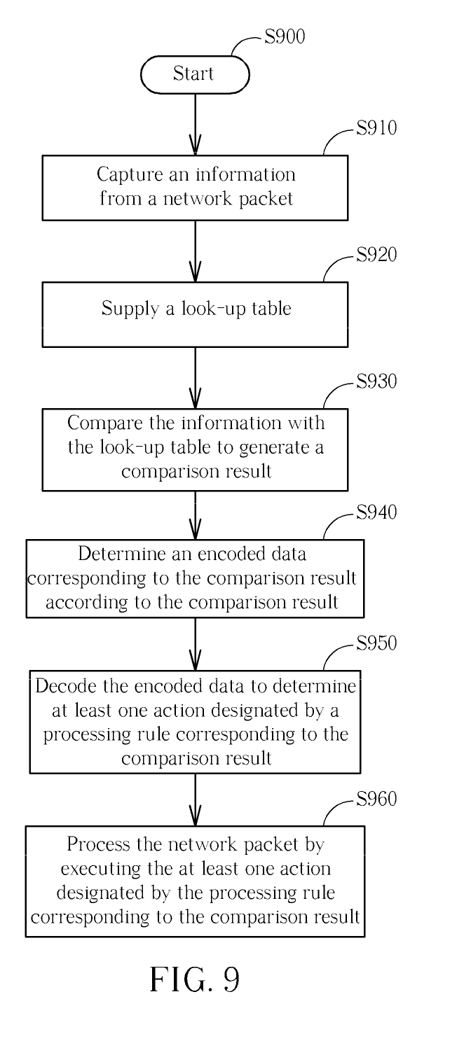

Please refer to FIG. 9, which is a flowchart of another operation example of a method for processing a network packet according to the present invention. The method includes the following steps:

Step S900: Start.

Step S910: Capture an information from a network packet.

Step S920: Supply a look-up table.

Step S930: Compare the information with the look-up table to generate a comparison result.

Step S940: Determine an encoded data corresponding to the comparison result according to the comparison result.

Step S950: Decode the encoded data to determine at least one action designated by a processing rule corresponding to the comparison result.

Step S960: Process the network packet by executing the at least one action designated by the processing rule corresponding to the comparison result.

The related operation details can be readily known from the steps shown in FIG. 9 and the elements shown in FIG. 5. Further description is omitted here for brevity.

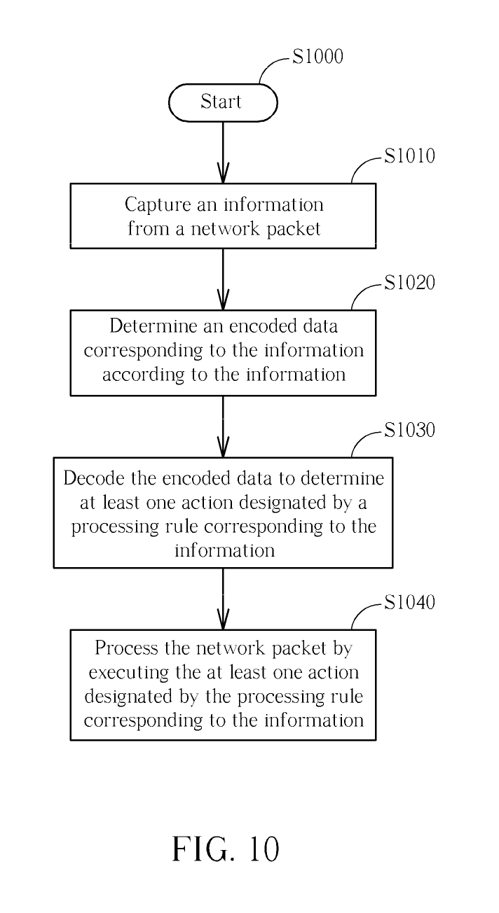

Please refer to FIG. 10, which is a flowchart of yet another operation example of a method for processing a network packet according to the present invention. The method includes the following steps:

Step S1000: Start.

Step S1010: Capture an information from a network packet.

Step S1020: Determine an encoded data corresponding to the information according to the information.

Step S1030: Decode the encoded data to determine at least one action designated by a processing rule corresponding to the information.

Step S1040: Process the network packet by executing the at least one action designated by the processing rule corresponding to the information.

The related operation details can be readily known from the steps shown in FIG. 10 and the elements shown in FIG. 7. Further description is omitted here for brevity.

As known from above, the present invention provides a device and a related method for processing a network packet. It processes the network packet by checking in advance to see whether an information of the packet conforms to a range, and thus reduces the use of access control list fields. In addition, sufficient action information is provided by encoding the actions. In this way, the storage space used by access control list rules is reduced, and so is the cost.

Those skilled in the art will readily observe that numerous modifications and alterations of the device and method may be made while retaining the teachings of the invention.

What is claimed is:

1. A device for processing a network packet, comprising:
a capturing unit, for capturing an information from the network packet;
a look-up table supplying unit, for supplying a look-up table;
a preprocessing unit, coupled to the capturing unit and the look-up table supplying unit, for comparing the information with the look-up table to generate a comparison result; and
a control unit, coupled to the preprocessing unit, for choosing a processing rule to process the network packet according to the comparison result.

2. The device of claim 1, wherein the look-up table has a plurality of table entries recording a plurality of information ranges respectively, and the preprocessing unit is utilized for comparing the information with the plurality of information ranges to generate the comparison result.

3. The device of claim 2, wherein the control unit comprises:
a ternary content addressable memory (TCAM), having at least one memory entry utilized for storing the comparison result; and
an executing unit, for reading the comparison result from the memory entry, and processing the network packet by executing at least one action designated by the processing rule corresponding to the comparison result.

4. The device of claim 1, wherein the control unit comprises:
a searching unit, for determining an encoded data corresponding to the comparison result according to the comparison result;
a decoding unit, coupled to the searching unit, for decoding the encoded data to determine at least one action designated by the processing rule corresponding to the comparison result; and
an executing unit, coupled to the decoding unit, for processing the network packet by executing the at least one action designated by the processing rule corresponding to the comparison result.

5. The device of claim 4, wherein either of each encoded data and a content of a corresponding action determined by each encoded data is stored by bits of a fixed bit length.

6. The device of claim 1, wherein the information is a source Internet Protocol address, a source Media Access Control (MAC) address, a virtual local area network identifier (VID), or a Transmission Control Protocol/User Datagram Protocol port.

7. A device for processing a network packet, comprising:
a capturing unit, for capturing an information from the network packet; and
a control unit, coupled to the capturing unit, for choosing a processing rule to process the network packet according to the information, the control unit comprising:
a searching unit, for determining an encoded data corresponding to the information according to the information;
a decoding unit, coupled to the searching unit, for decoding the encoded data to determine at least one action designated by the processing rule corresponding to the information; and
an executing unit, coupled to the decoding unit, for processing the network packet by executing the at least one action, designated by the processing rule corresponding to the information.

8. The device of claim 7, wherein either of each encoded data and a content of a corresponding action determined by each encoded data is stored by bits of a fixed bit length.

9. The device of claim 7, wherein the information is a source Internet Protocol address, a source Media Access Control (MAC) address, a virtual local area network identifier (VID), or a Transmission Control Protocol/User Datagram Protocol port.

10. A method for processing a network packet, comprising:
capturing an information from the network packet;
supplying a look-up table;
comparing the information with the look-up table to generate a comparison result; and
choosing a processing rule to process the network packet according to the comparison result.

11. The method of claim 10, wherein the look-up table has a plurality of table entries recording a plurality of information ranges respectively, and the step of choosing the processing rule to process the network packet according to the comparison result comprises:
comparing the information with the plurality of information ranges to generate the comparison result.

12. The method of claim 11, wherein the step of choosing the processing rule to process the network packet according to the comparison result comprises:
utilizing one memory entry in a ternary content addressable memory to store the comparison result; and
reading the comparison result from the memory entry, and processing the network packet by executing at least one action designated by the processing rule corresponding to the comparison result.

13. The method of claim 11, wherein the step of choosing the processing rule to process the network packet according to the comparison result comprises:
determining an encoded data corresponding to the comparison result according to the comparison result;
decoding the encoded data to determine at least one action designated by the processing rule corresponding to the comparison result; and
processing the network packet by executing the at least one action designated by the processing rule corresponding to the comparison result.

14. The method of claim 13, wherein either of each encoded data and a content of a corresponding action determined by each encoded data is stored by bits of a fixed bit length.

15. The method of claim 10, wherein the information is a source Internet Protocol address, a source Media Access Control (MAC) address, a virtual local area network identifier (VID), or a Transmission Control Protocol/User Datagram Protocol port.

16. A method for processing a network packet, comprising:
capturing an information from the network packet;
determining an encoded data corresponding to the information according to the information;
decoding the encoded data to determine at least one action designated by the processing rule corresponding to the information; and
processing the network packet by executing the at least one action designated by the processing rule corresponding to the information.

17. The method of claim 16, wherein either of each encoded data and a content of a corresponding action determined by each encoded data is stored by bits of a fixed bit length.

18. The method of claim 16, wherein the information is a source Internet Protocol address, a source Media Access Control (MAC) address, a virtual local area network identifier (VID), or a Transmission Control Protocol/User Datagram Protocol port.
